(19) United States
(12) Patent Application Publication
(10) Pub. No.: US 2004/0177864 A1
(43) Pub. Date: Sep. 16, 2004

(54) Carboy bottle cleaner

(76) Inventor: Angelo Segalla, Weedville, PA (US)

Correspondence Address: John W. McIlvaine, Webb Ziesenheim Logsdon Orkin & Hanson, P.C., 700 Koppers Building, 436 Seventh Avenue, Pittsburgh, PA, 15219, US

(21) Appl. No.: 10/387,979

(22) Filed: Mar. 13, 2003

(51) Int. Cl. B08B 9/36

(52) U.S. Cl. 134/8; 15/211; 15/164; 15/101

(57) ABSTRACT

A brush for cleaning a carboy includes a flexible substrate, e.g., a chamois attached to a first end portion of a shaft. The chamois has opposed major surfaces lying in an imaginary plane that is parallel to the long axis of the shaft. Cleaning fluid, e.g., soap and water, is applied to the chamois and the first end of the shaft is inserted into the carboy. The opposite end of the shaft rotated, e.g., by a hand-held drill, and centrifugal force moves the edges of the chamois against the interior walls of the carboy cleaning it.

### BACKGROUND OF THE INVENTION

1. Field of the Invention

This invention relates to a device, e.g., a brush, and a method for cleaning the interior of a container, e.g., a reusable container for storing liquid and, more particularly, to a brush and a method for using the brush to clean the interior surfaces of glass carboys, e.g., used for fermentation.

1. Description of Related Art

In the process of making wine, crushed grapes are pressed to extract the liquid, and the liquid is stored in barrels and/or carboys during fermentation. After fermentation is completed, the wine is stored in the barrels and/or carboys until needed, or the wine is transferred from the barrels and carboys to smaller bottles for storage, use and/or sale. After the barrels and carboys are empty, they are cleaned and stored until needed.

The barrels are easier to clean than carboys because the barrels are usually made of wood in sections secured together by metal straps or rings. The barrels are usually cleaned by removing the straps to open one end of the barrel. The carboys, on the other hand, are more difficult to clean. More particularly, the carboy is usually a glass container holding one or more gallons of liquid, e.g., wine in this discussion. In general, a 5 gallon capacity carboy has a neck about 4 inches (10.16 centimeters (“cm”)) high with about a 1.5 inches (3.81 cm) diameter passageway providing access to the interior of the carboy, a body of about 15 inches (38.1 cm) in diameter, and a shoulder providing the transition from the neck to the body.

During the fermenting cycle, residue adheres to the inside surface of the carboy, e.g., near the shoulder and neck of the carboy. The inner or interior surface of the neck and body of the carboy are easily cleaned using bottle brushes because the center axis of the interior walls of the passageway in the neck and the body of the carboy are coincident and have constant diameters throughout their length. The interior surface of the shoulder, on the other hand, is more difficult to clean because the interior surface of the shoulder, although having its axis coincident with the axis of the passageway in the neck and body of the carboy, has an increasing diameter from the neck to the body of the carboy or visa versa.

With this configuration, the interior surface of the shoulder generally lies in a plane transverse to the plane of the interior surface of the body of the carboy. As is appreciated by those skilled in the art, cleaning instruments inserted through the passageway in the neck to clean the interior walls of the carboy are limited by the diameter of the passageway. More particularly, inserting a brush having a width of greater than 14 inches (35.56 cm) to reach the interior surfaces of the body and shoulder of the carboy would have few bristles or greatly spaced bristles so that it can be passed through the passageway in the neck. Reducing the number of bristles or increasing the space between the bristles does not effectively clean the interior surface of the shoulder.

As can be appreciated, it would be advantageous to provide a brush and method of cleaning the interior surfaces of a carboy, in particular, the interior surface of the shoulder of a carboy.

### SUMMARY OF THE INVENTION

The invention herein relates to a brush for wiping, e.g., cleaning the interior surfaces of a carboy. The carboy in general has a base, a body connected to the base, the body usually having a constant diameter throughout its length and an outside diameter, a neck having a passageway and an outside diameter less than the outside diameter of the body and a shoulder connecting the neck to the body, the neck further including a passageway to provide access to the interior of the carboy.

The brush having features of the invention includes an elongated rigid member having a first end portion and an opposite end portion defined as a second end portion and a long axis; a flexible substrate having a pair of opposed major surfaces with the major surfaces of the material in a flat position lying in an imaginary plane. In one non-limiting embodiment of the invention, the flexible member is a cloth, e.g., a synthetic chamois or drying cloth, having a first edge and an opposite edge defined as a second edge, with the long axis of the rigid member extending between the first and second edges of the cloth and further including at least two slits in the cloth, one slit extending from the first edge toward the second edge and terminating short of the rigid member and the other slit extending from the second edge toward the first edge and terminating short of the rigid member. In another non-limiting embodiment of the invention, the rigid member is a cylindrical shaft made of a material selected from the group consisting of plastic, metal, plastic-coated metal, aluminum, fiberglass reinforced plastic, and mixtures thereof. The substrate is mounted on the first end portion of the rigid member with the long axis of the rigid member parallel to the imaginary plane. Fasteners, e.g., rivets, pass through the first end portion of the rigid member and flexible substrate to secure the flexible substrate on the first end portion of the shaft.

The invention further relates to a method of cleaning the carboy using non-limiting embodiments of the above-described brush. The method includes the step of applying a cleaning fluid to the flexible substrate, e.g., applying water and soap or bleach to selected edges of the flexible substrate. Thereafter, the first end of the shaft of the brush is inserted through the passageway in the neck of the carboy. The shaft is rotated, e.g., by a hand held drill at a sufficient speed to generate centrifugal force sufficient to move sides of the flexible member outward from the shaft against interior walls of the carboy, while the shaft and carboy are moved relative to one another to clean the interior surfaces of the carboy. The flexible member as it moves over the interior surface of the shoulder toward the passageway in the neck is compressed.

In a non-limiting embodiment of the method of the invention, the flexible member is a cloth having a first edge and an opposite edge defined as a second edge with the long axis of the rigid member extending between the first and second edges of the cloth and the step of providing a brush includes the step providing at least two slits in the cloth, one slit extending from the first edge toward the second edge and terminating short of the rigid member and the other slit extending from the second edge toward the first edge and terminating short of the rigid member.

The invention also relates to a carboy cleaned according to the above non-limiting methods of the invention.

### BRIEF DESCRIPTION OF THE DRAWINGS

FIG. 1 is a plan elevated view of a non-limiting embodiment of a brush incorporating features of the invention for cleaning a carboy;

FIG. 2 is a side elevated view of a carboy having the brush shown in FIG. 1 adjacent the base of the carboy; and

FIG. 3 is a view similar to the view of FIG. 2 showing the brush in the passageway in the neck of the carboy.

### DETAILED DESCRIPTION OF THE INVENTION

Before discussing the non-limiting embodiments of the invention, it is to be understood that the invention is not limited in its application to the details of the particular embodiments shown and discussed since the invention is capable of other embodiments. Further the terminology used herein is for the purpose of description and not of limitation.

As used herein, spatial or directional terms, such as “inner”, “outer”, “left”, “right”, “up”, “down”, “horizontal”, “vertical”, and the like, relate to the invention as it is shown in the drawing figures. However, it is to be understood that the invention can assume various alternative orientations and, accordingly, such terms are not to be considered as limiting. In the following discussion, unless indicated otherwise, like numbers refer to like elements.

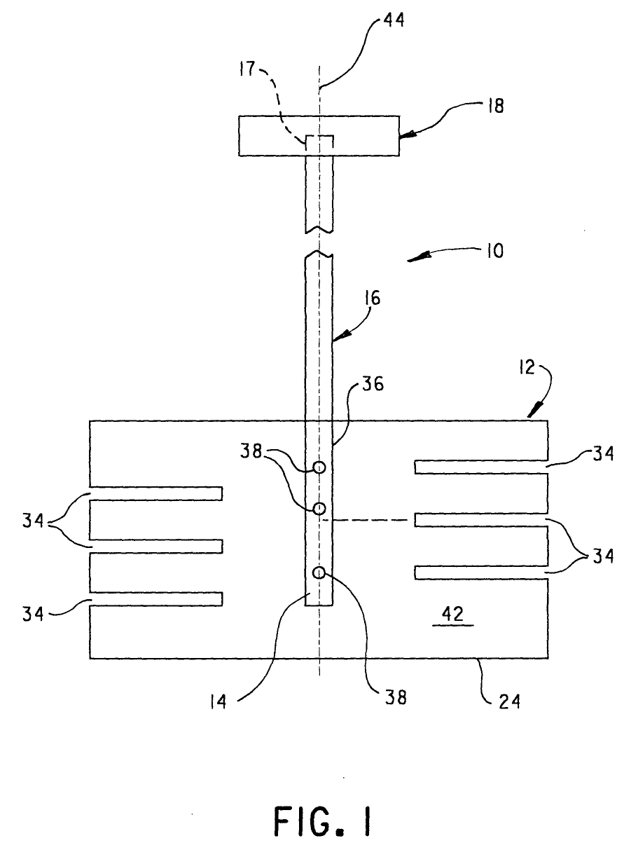

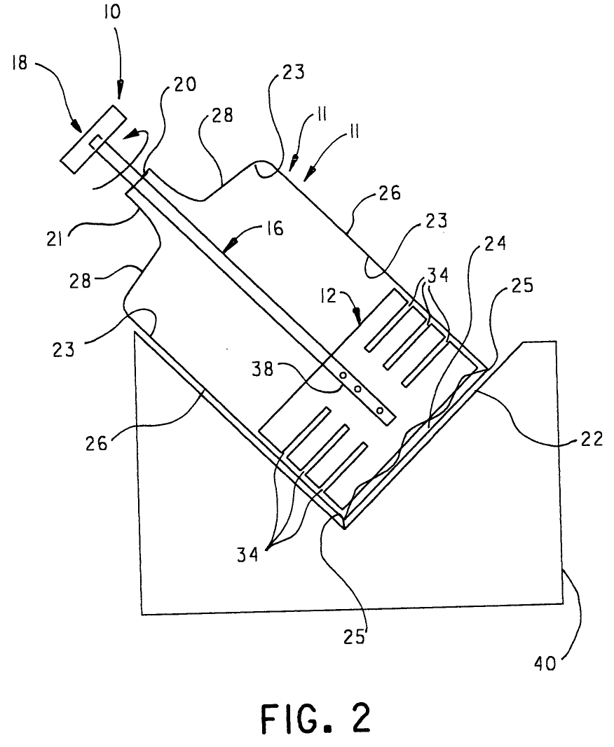

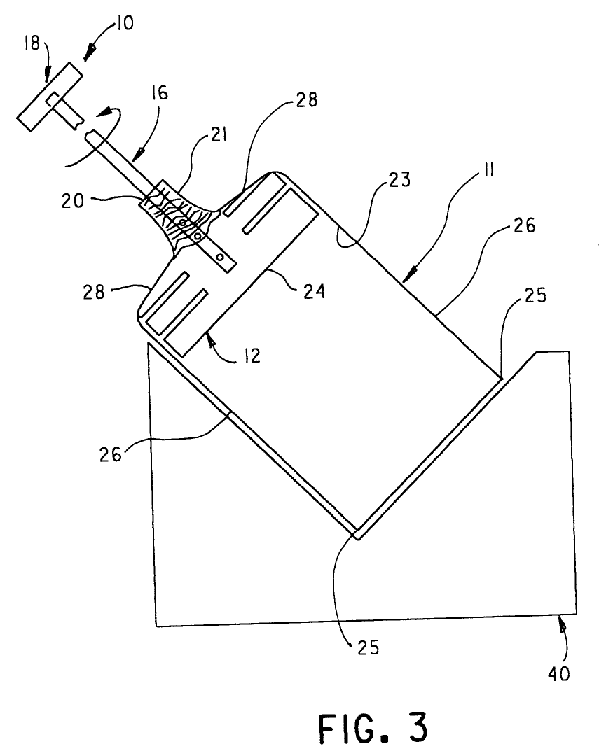

With reference to FIG. 1 there is shown a non-limiting embodiment of a brush 10 incorporating features of the invention for cleaning the interior of a carboy, e.g., of the type shown in FIG. 2 and identified by the number 11. With continued reference to FIG. 1, the brush 10 includes a flexible substrate 12 mounted to end portion 14 of shaft 16 with the other end 17 of the shaft 16 mounted to a power device 18 to rotate the shaft 16 in a first direction along a circular path, e.g., in a clockwise direction, or in a second direction along a circular path opposite to the first direction, e.g., in a counterclockwise direction, or along a reciprocating circular path, e.g., alternating between a clockwise direction and a counter-clockwise direction (see FIGS. 2 and 3).

The material of the flexible substrate 12 is not limiting to the invention and can be any flexible material and is preferably, but not limiting to the invention, a material that can absorb cleaning fluids, e.g., soap and water. With reference to FIGS. 1-3 as required, the substrate 12 is flexible so that it is easily inserted through passageway 20 in neck 21 of the carboy 11, and during the cleaning of interior surfaces 23 of the carboy, changes in configuration as the shape of the interior surfaces of the carboy 11 change for ease of cleaning the interior surfaces of the carboy. More particularly, during the cleaning of the inner surface of the bottom or base 22 of the carboy (see FIG. 2), bottom portion 24 of the substrate 12 will gather at the inner surface of the base 22. As the shaft 16 of the brush 10 rotates, the flexible substrate wipes and cleans the inner surfaces of the base 22, corner 25, and portions of the interior surface of the body 26 of the carboy 11. The shaft 16 is simultaneously rotated and pulled through the passageway 20, e.g., to the left and upward as viewed in FIG. 2, to move the flexible substrate 12 over the interior surface of the body 26 of the carboy and in a direction toward the shoulder 28 to clean the interior surfaces of the body of the carboy. With reference to FIG. 3, continued movement of the shaft 16 moves the flexible substrate into contact with the inner surface of the shoulder 28. As the shaft further moves out of the carboy interior, the flexible substrate conforms to the interior surface portions at the shoulder 28 and interior surface of the passageway 20 of the neck 21.

In the practice of the invention, the flexible substrate 12 can be a cloth, desirably, but not limiting to the invention, a cloth that absorbs cleaning liquid, e.g., but not limiting to the invention, water and soap and/or commercially available cleaning solutions for cleaning glassware designated to contain food. In the practice of the invention, a synthetic chamois was used, e.g., of the type sold by Clean Rite of Atlanta, Ga. under the mark Ultra Dry drying cloth No. 114250. The flexible substrate 12 shown in FIG. 1 has cut out portions 34 to make the cloth more flexible and reduce wind resistance as the shaft is rotated. As can be appreciated, the invention is not limited to the embodiment of the flexible substrate shown in FIG. 1 and additional non-limiting embodiments of the invention contemplate having a substrate with no cut outs or more than 3 or less than 3 cut outs. Further, the invention contemplates having strips of flexible material mounted to the end portion 14 of the shaft in place of one flexible substrate. Still further, the invention contemplates adding the cleaning fluid to the flexible substrate before inserting the brush through the passageway 20 in the neck 21, after the brush is inserted in the carboy, e.g., adding the cleaning fluid to the carboy before inserting the brush in the carboy, or after the motor is energized to rotate the shaft.

The material of the shaft 16 is not limiting to the invention and is preferably a rigid material that is resistant to deterioration from the cleaning fluid, e.g., but not limiting to the invention, rust from interaction with water. Materials that are preferred in the practice of the invention but not limiting thereto are wood, plastic, plastic-coated steel, aluminum, stainless steel, fiberglass reinforced plastics, to name a few. The flexible substrate 12 is mounted to the end portion 14 of the shaft 16 in any convenient manner. For example, in a non-limiting embodiment of the invention, a slot 36 (not shown but designated) is provided in the end portion 14 of the shaft 16 to receive the substrate 12. Rivets 38 pass through holes (not shown) in the end portion 14 of the shaft 16 and are secured in position to secure the flexible substrate 12 on the end portion 14 of the shaft 16. As can be appreciated, the invention is not limited to the bolt and nut assemblies to secure the flexible substrate and any type of fasteners may be used, e.g., but not limiting thereto, nut and bolt assemblies, nails, screws and adhesives. The flexible member 12 is preferably mounted on the shaft 16 with the flexible member flat, e.g., the major surfaces 42 (only one shown in FIG. 1) of the substrate 12, lying in an imaginary plane parallel to long axis 44 of the shaft 16 as shown in FIG. 1. In this manner, except for cleaning the shoulder 28 and passageway 20 in the neck 21, as the shaft rotates the flexible substrate is fully opened for maximum edge area contact with the interior surface of the carboy.

As can now be appreciated, the invention is not limited to the power source used to rotate the shaft and/or move the shaft in and out of the carboy. For commercial use, the equipment should be selected to rapidly and thoroughly clean the inner surfaces of the carboy. For non-commercial use, a hand-held electric or battery operated drill or a drill mounted on a stand can be used. More particularly, for home use, the equipment available is usually, but not limiting the invention thereto, a ¼, ⅜, or ½ inch hand-held drill. As can be appreciated, the drill should have sufficient speed and torque to rotate the shaft and move the substrate by centrifugal force outward into contact with the inner walls 23 of the carboy 11. Increasing the weight of the substrate by saturating the substrate with cleaning fluid, e.g., water, increases the amount of torque required to rotated the shaft to move the flexible substrate outward against the inner walls of the carboy.

Providing the slots 34 in the flexible substrate reduces the wind resistance as the substrate rotates. In the practice of the invention, but not limiting thereto, a chamois cloth is preferred because it is flexible, durable and portions of the chamois can be wetted, e.g., the end portions to contact the interior walls of the carboy.

The carboy 11 in FIGS. 2 and 3 can be mounted on a platform 40 for ease of inserting the brush 10 into and out of the passageway 20 in the neck 21. As can be appreciated, the invention is not limited thereto and the position of the carboy 11 may be vertical with the neck 21 facing upward or downward, or the carboy may be horizontal with the neck 21 facing the right or left as viewed in FIGS. 2 and 3.

The invention was practiced using an Ultra Dry drying cloth (a synthetic chamois). The purchased cloth was 2.5 square feet (0.23 square meters) and was cut to provide a piece having a width of 14 inches (35.6 cm) and a height of 7.5 inches (19 cm). The cloth extended about ½ inch (1.27 cm) beyond the end portion 14 of the shaft 16 to provide a margin of error to avoid the shaft from rotating on the base 24 of the carboy. The shaft was made of stainless steel and had a diameter of ⅜ inches (0.9525 cm). The invention is not limited to the dimensions of the brush, however, as can now be appreciated the thickness of the brush and the flexible member wrapped around the brush should not exceed the diameter of the passageway 20 in the neck 21 of the carboy. The greater the difference, the easier it is to insert and to remove the brush.

Although the discussion was directed to having one substrate secured to the end of portion 14 of the shaft 16, the invention is not limited thereto. For example, and with reference to FIG. 1, there is shown dotted line 44 to show that two or more flexible substrates may be secured to the end portion 14 of the shaft 16.

As can be appreciated by those skilled in the art, the particular embodiments described in detail herein are illustrative only and are not limiting to the scope of the invention, which is to be given the full breadth of the appended claims and any and all equivalents thereof.

The invention claimed:

1. A brush for wiping the interior surfaces of a carboy comprising:
an elongated rigid member having a first end portion and an opposite end portion defined as a second end portion and a long axis;
a flexible substrate having a pair of opposed major surfaces with the major surfaces of the material in a flat position lying in an imaginary plane, the substrate mounted on the first end portion of the rigid member with the long axis of the rigid member parallel to the imaginary plane; and
fasteners passing through the first end portion of the rigid member and flexible substrate to secure the flexible substrate on the first end portion of the shaft.

2. The brush according to claim 1, wherein the rigid member is a cylindrical shaft and further including a motor mounted on the second end portion of the shaft.

3. The brush according to claim 1, wherein the rigid member is made of a material selected from the group consisting of plastic, metal, plastic-coated metal, aluminum, fiberglass reinforced plastic, and mixtures thereof.

4. The brush according to claim 3, wherein the flexible member is a cloth having a first edge and an opposite edge defined as a second edge with the long axis of the rigid member extending between the first and second edges of the cloth and further including at least two slits in the cloth, one slit extending from the first edge toward the second edge and terminating short of the rigid member and the other slit extending from the second edge toward the first edge and terminating short of the rigid member.

5. The brush according to claim 4, wherein the rigid member is a cylindrical shaft made of stainless steel.

6. The brush according to claim 5, wherein the fasteners are rivets.

7. The brush according to claim 6, further including a hand-held drill mounted to the second end of the shaft.

8. The brush according to claim 7, wherein the cloth is a chamois.

9. The brush according to claim 8, wherein the chamois is a synthetic chamois.

10. The brush according to claim 1, wherein the flexible substrate is a first substrate and further including a second substrate mounted on the first end portion of the rigid member spaced from the first substrate.

11. A method of cleaning a carboy, the carboy having a base, a body connected to the base, the body having an outside diameter, a neck having a passageway and an outside diameter less than the outside diameter of the body and a shoulder connecting the neck to the body, the neck further including a passageway to provide access to the interior of the carboy, the method comprising the steps of:
providing a brush, the brush comprising:
an elongated rigid member having a first end portion and an opposite end portion defined as a second end portion and a long axis;
a flexible substrate having a pair of opposed major surfaces with the major surfaces of the material in a flat position lying in an imaginary plane, the substrate mounted on the first end portion of the rigid member with the long axis of the rigid member parallel to the imaginary plane; and
fasteners passing through the first end portion of the rigid member and flexible substrate to secure the flexible substrate on the first end portion of the shaft;
applying a cleaning fluid to the flexible substrate;
inserting the first end of the brush through the passageway in the neck of the carboy; and
rotating the shaft at a sufficient speed for the centrifugal force generated by the rotation of the shaft to move sides of the flexible member outward from the shaft against interior walls of the carboy, while moving the shaft and carboy relative to one another to clean the interior surfaces of the carboy.

12. The method according to claim 10, wherein the body of the carboy has a constant diameter throughout its length and further including the step of removing the brush from the interior of the carboy.

13. The method according to claim 11, wherein the flexible member as it moves over the interior surface of the shoulder toward the neck in a direction away from the base compresses the flexible member.

14. The method according to claim 13, wherein the step of rotating the shaft comprises the steps of connecting a hand-held drill to the second end of the shaft and powering on the drill.

15. The method according to claim 14, wherein the step of applying the cleaning fluid to the flexible substrate comprises the step of applying the cleaning liquid to selected edges of the flexible substrate.

16. The method according to claim 15, wherein the flexible substrate is a chamois and the shaft is a stainless steel shaft and the cleaning fluid includes a solution of water and cleaner.

17. The method according to claim 14, further including the step of positioning the carboy such that a long axis through the passageway in the neck of the carboy subtend an oblique angle with the floor on which the carboy is supported.

18. The method according to claim 17, further including the step of mounting the carboy on a base with the base supported on the floor.

19. The method according to claim 11, wherein the flexible member is a cloth having a first edge and an opposite edge defined as a second edge with the long axis of the rigid member extending between the first and second edges of the cloth and the step of providing a brush includes the step of providing at least two slits in the cloth, one slit extending from the first edge toward the second edge and terminating short of the rigid member and the other slit extending from the second edge toward the first edge and terminating short of the rigid member.

20. A carboy cleaned according to the method of claim 11.
